(19) United States
(12) Patent Application Publication
(10) Pub. No.: US 2016/0240301 A1
(43) Pub. Date: Aug. 18, 2016

(54) Magnetic Member and Wireless Power Transmission Device Comprising Same

(71) Applicant: LG INNOTEK CO., LTD., Seoul (KR)

(72) Inventors: Jai Hoon Yeom, Seoul (KR); Sang Won Lee, Seoul (KR); So Yeon Kim, Seoul (KR); Seok Bae, Seoul (KR); Ji Yeon Song, Seoul (KR)

(21) Appl. No.: 15/027,151

(22) PCT Filed: Oct. 1, 2014
(86) PCT No.: PCT/KR2014/009248

§ 371 Date: Apr. 4, 2016

(30) Foreign Application Priority Data
Oct. 2, 2013 (KR) 10-2013-0117641
Dec. 6, 2013 (KR) 10-2013-0151646

(51) Int. Cl. H01F 27/245; H02J 50/80; H01F 1/08; H01F 27/28; H01F 1/047; H02J 50/12; H02J 7/02

(52) U.S. Cl. CPC H01F 27/245; H02J 50/12; H02J 50/80; H02J 7/025; H01F 27/2804; H01F 1/047; H01F 1/086

(57) ABSTRACT

A magnetic sheet applied to a wireless charging module is provided. The magnetic sheet according to embodiments of the present invention may be compatible with a variety of standards of wireless power transmission methods and implement high power transmission efficiency while minimizing influence of a permanent magnet in a power transmission method that requires the permanent magnet.

### TECHNICAL FIELD

The present invention relates to a magnetic member applied to a wireless power conversion device.

### BACKGROUND ART

A magnetic material is used in an information technology (IT) component module for a wireless power transmission such as a near field communication (NFC) module, and due to the use of the magnetic material, an effort to enhance a function and a performance of transmission efficiency, i.e., wireless power transmission efficiency, by minimizing electromagnetic energy loss by employing an electromagnetic shielding material, i.e., a magnetic material, has continued beyond a practice of relying only on a coil design.

In terms of the electromagnetic shielding material formed of a magnetic material, a shielding material capable of satisfying a function of wireless power transmission is necessary, but such a shielding material shows a limit in compatibility due to a diversification in standard methods for wireless power transmission. Representative examples of standard methods for the wireless power transmission includes wireless power consortium (WPC), alliance for wireless power (A4WP), and power matters alliance (PMA), and the wireless power transmission methods are technically classified into magnetic induction methods and magnetic resonance methods.

Specifically in terms of an IT component, whether a permanent magnet is adopted inside a transmitting unit or a receiving unit makes a major difference, that is, according to whether the permanent magnet is adopted, much difference is shown in wireless power transmission efficiency depending on each standard, and an application to various designs is different.

According to an A1-type standard of a WPC transmitting unit, a permanent magnet is included in a center of a power transmitting unit regardless of an implemented function of magnetic induction or magnetic resonance. The reason the permanent magnet is installed is to correct positions of a transmitting antenna and a receiving antenna to optimum positions. For each function to be exhibited with a maximum performance consistent with the variety of the above-mentioned standard methods, each standard requires a different material and structure of a magnetic member. For this, there is a problem that a material and a structure of the magnetic members have to be changed, but a magnetic material having compatibility consistent with the variety of standard methods described above has yet not been developed.

In addition, antennas of NFC and WPC systems are each configured to include a certain area of a coil to be provided with energy required for an operation of a microchip from a reader. A magnetic field formed by alternating current (AC) power energy generated from a primary coil of the reader passes through a coil of an antenna to induce a current, and a voltage is generated due to an inductance of the antenna. The voltage generated as described above is used as power for transmitting data or charging a battery. Efficiency of a power transmission between the primary coil and a secondary coil is associated with an operating frequency, a cross-sectional area of the secondary coil, and a distance and an angle between the primary coil and the secondary coil, but an operating distance is relatively short due to a limit of a current amount which flows at an antenna side. To secure the operating distance described above, a magnetic layer which serves a function of shielding electromagnetic-waves is formed on the secondary coil of the antenna. A need for a soft magnetic substrate capable of securing a minimum operating distance of the antenna side formed as above while minimizing a manufacturing cost is growing.

### DISCLOSURE

### Technical Problem

The present invention is directed to providing a magnetic member capable of implementing a high efficiency wireless power transmission and minimizing influence of a permanent magnet in a wireless power transmission method that requires the permanent magnet while being compatible with a variety of standards of wireless power transmission methods.

The present invention is also directed to providing a soft magnetic substrate capable of forming a recognition distance of the soft magnetic substrate from a transmission side to be a minimum recognition distance or more as well as minimizing a manufacturing cost by forming an opening at the central portion of the soft magnetic layer disposed above a coil pattern to reduce an area that the soft magnetic layer occupies.

### Technical Solution

One aspect of the present invention provides a magnetic member which includes a cross section provided with a first width x of a first direction and a second width y of a second direction perpendicular to the first direction, and a thickness z which extends from the cross section, wherein a ratio of an area of the cross section to the thickness z is in the range of 1:(0.0002˜1).

Another aspect of the present invention provides a magnetic member which includes a soft magnetic layer having a cross section provided with a first width x of a first direction, a second width y of a second direction perpendicular to the first direction, and a thickness z which extends from the cross section, and an opening in the thickness z direction, and a coil pattern on the soft magnetic layer, wherein the soft magnetic layer includes an area which corresponds to the coil pattern, and an area which extends from the area which corresponds to the coil pattern.

### Advantageous Effects

The magnetic member according to the embodiments of the present invention can provide effects of being compatible with a variety of standard methods of wireless power transmission and implementing high power transmission efficiency while minimizing influence of a permanent magnet in a power transmission method that requires the permanent magnet.

More specifically, by minimizing influence of a permanent magnet in a latest wireless power transmitting unit and receiving unit having a permanent magnet regardless of employing a permanent magnet in a transmitting unit and a receiving unit of Tx-A1 (a representative standard on a transmitting unit including a permanent magnet) and Tx-A11 (a representative standard on a transmitting unit without a permanent magnet), the magnetic member according to the embodiments of the present invention has an advantageous effect of implementing high efficiency wireless power transmission.

In addition, the magnetic member according to the embodiments of the present invention can maximize wireless power transmission efficiency by applying an excellent magnetic material effective in wireless power transmission and implement an advantage of extending applications to include small hand-held gadgets such as a mobile phone or the like, various devices of telecommunications and information technology (IT), and large devices such as an organic light emitting diode (OLED), a hybrid electric vehicle (HEV), an electric vehicle (EV) etc. because a variety of magnetic material is applicable regardless of new standards.

Furthermore, the soft magnetic substrate according to the embodiments of the present invention can form a recognition distance of the soft magnetic substrate from a transmitter side to be a minimum recognition distance or more as well as reducing the area that the soft magnetic layer occupies on the magnetic member to minimize a manufacturing cost by forming the opening at the central portion of the soft magnetic layer disposed above the coil pattern.

### BRIEF DESCRIPTION OF THE DRAWINGS

FIG. 1 is a conceptual diagram illustrating a structure of a magnetic member according to one embodiment of the present invention;

FIGS. 2 and 3 are conceptual diagrams illustrating modified embodiments of structures of magnetic members according to one embodiment of the present invention;

FIGS. 4 to 7 are graphs illustrating experimental data according to one embodiment of the present invention;

FIG. 8 is a diagram illustrating a wireless power conversion (WPC) system or a near field communication (NFC) system in which a magnetic member according to another embodiment of the present invention is applied;

FIGS. 9 to 10 are conceptual diagrams illustrating a magnetic member which forms a transmitting device or a receiving device described in FIG. 8 according to one embodiment of the present invention;

FIG. 11 is a cross-sectional view of a soft magnetic substrate according to yet another embodiment of the present invention;

FIGS. 12 and 13 are views for describing a magnetic member according to one embodiment of the present invention; and

FIG. 14 is a table for describing recognition distances of magnetic members according to embodiments of the present invention, and FIG. 15 is a graph for describing the recognition distances of the magnetic members according to the embodiments of the present invention.

### MODES OF THE INVENTION

Hereinafter, configurations and operations according to the embodiments of the present invention will be described in detail with reference to the accompanying drawings. In the description referencing the accompanying drawings, like elements are designated by the same reference numerals regardless of reference numbers, and duplicated descriptions thereof will be omitted. Although the terms “first,” “second,” etc. may be used herein to describe various elements, these elements should not be limited by these terms. These terms are only used to distinguish one element from another.

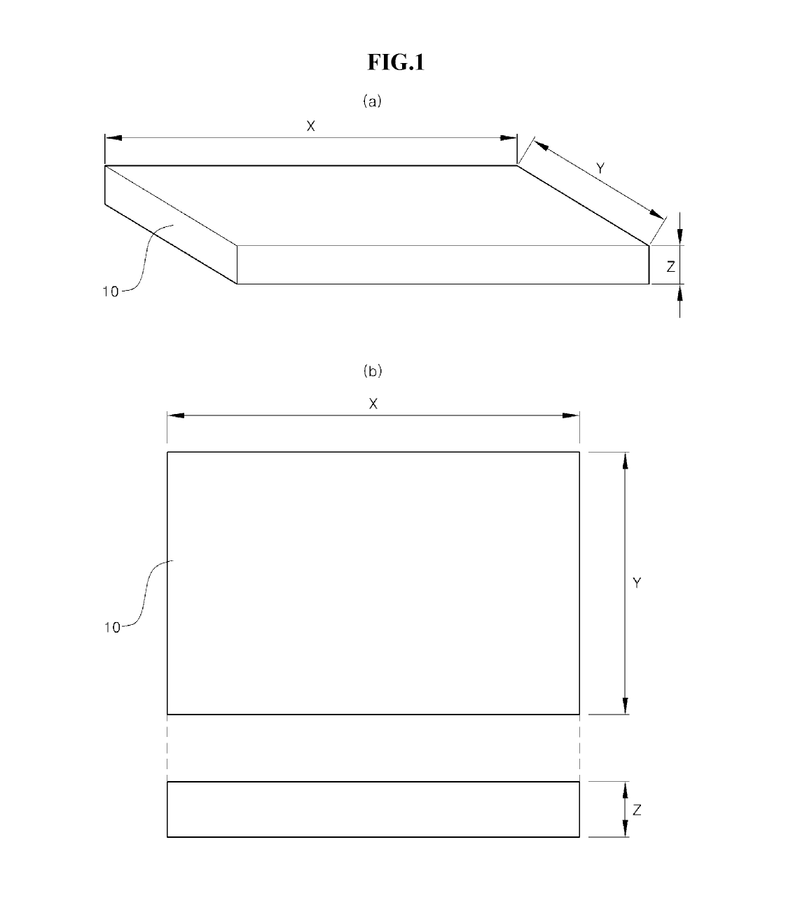

FIG. 1 is a conceptual diagram illustrating a structure of a magnetic member according to one embodiment of the present invention.

Referring to FIG. 1, a magnetic member 10 according to one embodiment of the present invention is provided with a cross section which includes a first width x of a first direction, a second width y of a second direction perpendicular to the first direction, and a thickness z which extends from a cross section, and the magnetic member 10 may be formed in a structure that satisfies a ratio of an area of the cross section to the thickness z in the range of 1:(0.0002˜1).

In the structure of FIG. 1, a cross sectional structure of a rectangle having a width and a length is illustrated, but the cross section is not limited thereto, and any sheet member having a cross sectional shape in various structures of a single closed curve having orientations of a first direction and a second direction and a uniform thickness is included in the scope of the present invention.

As illustrated, the magnetic member 10 is provided with the first width x as a length of the first direction and the second width y as a length of the second direction y perpendicular to the first width x, and the first width x is defined as the longest line segment of the cross section in a horizontal direction and the second width y is defined as the longest line segment in a perpendicular direction to the first width. In addition, an embodiment of the present invention satisfies the ratio of the area of the cross section area serving as a plane formed by the first width and the second width to the thickness of the magnetic member in the range of 1:(0.0002˜1).

(Particularly, the first width x is defined as the longest line segment of the cross section in the horizontal direction and the second width y is defined as the longest line segment in the perpendicular direction to the first width, and an applied unit in defining the ratio of the area to the thickness as described above is the millimeter (mm). When the unit is changed, because a numerical ratio changes at a rate of 10a (a is a rational number), the applied unit is provided (expressed), and the determined ratio needs to be calculrated and defined in terms of a comparison. In addition, in the method of calculating the ratio, a calculated ratio is defined by applying only numerical values and disregarding units because an area unit ‘mm²’ and a thickness unit ‘mm’ are physically different from each other.)

In a wireless power transmission module including an ordinary magnetic member, when a permanent magnet is positioned at the center of a transmission antenna, a magnetic member at a receiving device is influenced, which causes a degradation phenomenon of permeability which is formed by a magnetic field induced by currents flowing at coils of transmitting and receiving devices. While the influence on a soft magnetic core of the transmitting device is less serious because of a thickness of several millimeters and a volume even though the permeability of a certain portion adjacent to the permanent magnet is degraded, a soft magnetic sheet as thin as a thickness of 0.1 mm to 0.3 mm retaining a high permeability characteristic in horizontal and vertical directions shows degradation of an induction phenomenon induced by an alternate current (AC) magnetic field formed by the coil because of a magnetization behavior caused by an adjacent permanent magnet. As a result, a leakage of electromagnetic energy at a transmitting antenna and a receiving antenna is not prevented, and thereby transmission efficiency is degraded. On the contrary, in an embodiment of the present invention that satisfies the ratio of an area of the cross section to a thickness in the range of 1:0.0002 to 1:1, the degradation phenomenon of the permeability is remarkably removed and the influence of the permanent magnet may be minimized.

When the above-described range of the ratio is satisfied, not only is transmission efficiency of the wireless power transmission increased, but also compatibility which is applicable to be compatible with various standards of power transmission regardless of the existence of a permanent magnet, which is applied to the various standards, is secured. On the contrary, in the case of deviation from the above-described range, the power transmission efficiency drops noticeably, and while it may be applied to a specific standard, it implements characteristics which are not proper to other standard methods due to a severe influence by the permanent magnet.

The magnetic member 10 according to one embodiment of the present invention, regardless of shape, is more preferable in that it satisfies an entire volume implemented as a magnetic substance in the range of 10³ mm³ to 10¹² mm³ which satisfies the range of the above-described ratio of the area of the cross section to the thickness. Compatibility and transmission efficiency of the wireless power transmission is further enhanced when the ratio of the area of the cross section of the magnetic layer to the thickness thereof satisfies the above-described range of volume.

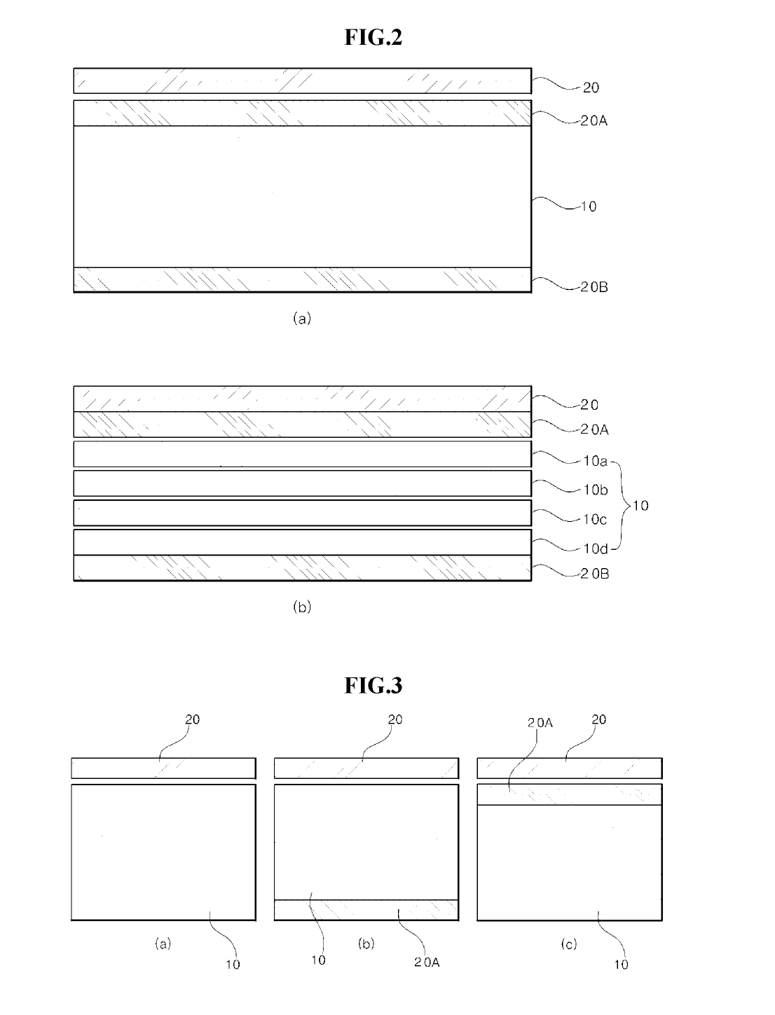

FIG. 2 illustrates conceptual diagrams of structures of magnetic members applied to a wireless power transmission or reception module according to one embodiment of the present invention.

According to FIG. 2, the magnetic member according to one embodiment of the present invention, as illustrated in FIG. 2(A), may be implemented by a single layer of a non-stacked structure which is configured to fall within the range which satisfies the ratio of the area of the cross section to the thickness according to the above-described embodiment of FIG. 1, or may be implemented by a stacked layer structure by a plurality of unit sheets of 110a to 110d as illustrated in FIG. 2(B) and may be implemented to fall within the range which satisfies the ratio of the area of the cross section to the thickness according to the above-described embodiment of FIG. 1.

Particularly, in the case of the stacked layer structure of the magnetic member as illustrated in FIG. 2(B), when implemented as a simple stacked layer structure implemented by each separated structure without interposing a medium substance such as an adhesive or the like, the influence of a permanent magnet may be dispersed to each separate unit sheet, thereby preventing the transmission efficiency from degrading in a standard method of a wireless power transmission module with the existence of a permanent magnet, in addition to which the dispersing efficiency of the above-described influence by the permanent magnet may be further enhanced by interposing an insulating layer such as an adhesive, an adhesive film or the like between the unit members of the sheets. In the case, it is preferable that a thickness of the unit sheet satisfies the range of 18 um to 200 um, and in the case of the stacked layer structure, it is preferable that a stacked layer structure stacked in the range of 2 layers to 30 layers be implemented while satisfying the ratio of the area of the cross section to the thickness in the magnetic member according to the above-described embodiment of the present invention in terms of efficiency that may be outside of the influence of the permanent magnet.

In the structure of FIG. 2, the magnetic member 10 may be applied to a wireless charging module as a structure further including cover films 20A and 20B on surfaces of the magnetic member 10, and in this case, a coil 20 for wireless power transmission may be additionally disposed on an upper surface of the magnetic member 10. FIG. 3 illustrates a structure of the magnetic member, a placement of the coil 20, and a modified arrangement of the cover film 20A according to one embodiment of the present invention.

Further, the magnetic member according to one embodiment of the present invention of FIGS. 1 and 2 may be formed of a composite material of a polymer and a metallic-alloy based magnetic powder formed of one element or a combination of two or more elements selected from Fe, Ni, Co, Mo, Si, Al and B, or may be formed by a metallic-alloy based magnetic ribbon. In the embodiment of the present invention, metallic alloys in a crystalline state or an amorphous state having a shape of a very thin band, a string, or a belt, are collectively referred to as a “ribbon.”

In addition, although the term “ribbon” defined in the embodiment of the present invention is a metallic alloy in principle, a particular term “ribbon” is used due to an appearance of a shape, and Fe(Co)—Si—B is used as a main material to form the ribbon, which may be manufactured in various types of compositions by adding additives such as Nb, Cu, Ni, etc. In a broad sense of the ribbon, an applicable material may include a fiber, a vinyl, a plastic, a metal, an alloy, or the like, but the ribbon in daily life may be manufactured chiefly in a form of a fiber or vinyl and may be used for the purpose of binding an object, decoration, or the like.

Alternatively, the magnetic member may be formed of a composite material of a polymer and a ferrite-based powder formed of a combination of two or more elements selected from Fe, Ni, Mn, Zn, Co, Cu, Ca, and O, or formed of a sintered ferrite, and a shape may be implemented as a sheet structure. For instance, the magnetic member according to one embodiment of the present invention may be formed of Fe—Si—B and a MnZn-based ferrite.

In any case, it is preferable that the magnetic member satisfies the ratio of the area of the cross section to the thickness z in the range of 1:(0.0002˜1), and more preferably that it satisfies a volume of the magnetic member in the range of 10³ mm³ to 10¹² mm³.

### EXPERIMENTAL EXAMPLE 1

In experimental example 1, a transmission efficiency of a wireless power transmission depending on a thicknesses of a magnetic member formed of Fe—Si—B material and a magnetic member formed of MnZn ferrite material is measured. A variation in the thickness of a sheet is given in the range of 0.1 mm to 0.3 mm, an LF5055ANT is applied as an antenna for the wireless power transmission, and a thickness of the coil is uniformly set to 0.1 mm. An area of the magnetic member applied is set to 50 mm by 55 mm (an area of 2750 mm²), a space between the magnetic member and the antenna is 0.03 mm, and an input power is applied in the range of 2.5 W to 3.5 W (power transmission methods were Tx-A11 and Tx-A1).

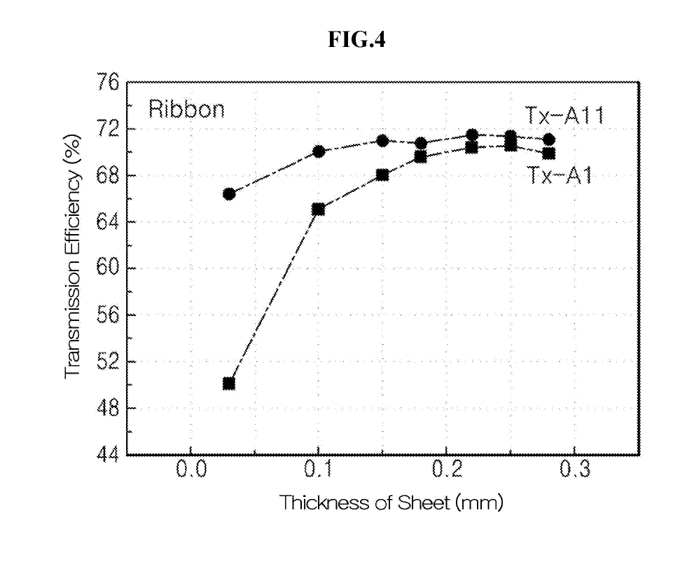

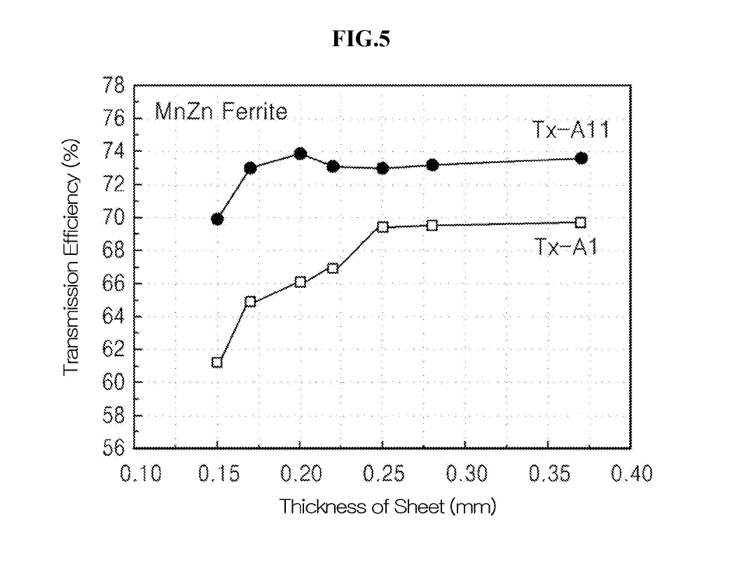

As a material for the magnetic member, a result illustrated in FIG. 4 is from applying an Fe—Si—B ribbon, and a result illustrated in FIG. 5 is from applying the MnZn ferrite. Referring to FIGS. 4 and 5, in any case the range of one embodiment of the present invention is satisfied, and the transmission efficiency is securable up to the range of 65% to 69% when the thickness of the sheet is increased, and thus it is confirmed that a desired degree (transmission efficiency for proper wireless charging) may be secured even in different transmission methods.

### EXPERIMENTAL EXAMPLE 2

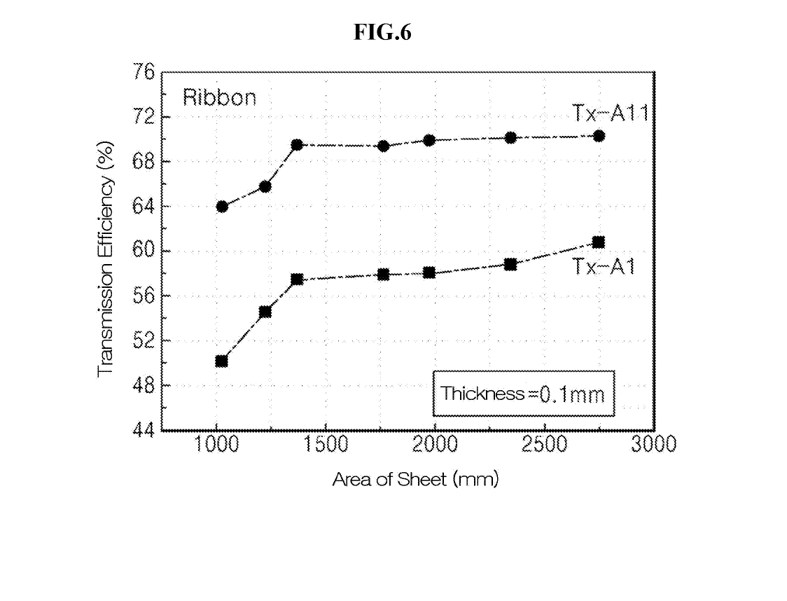

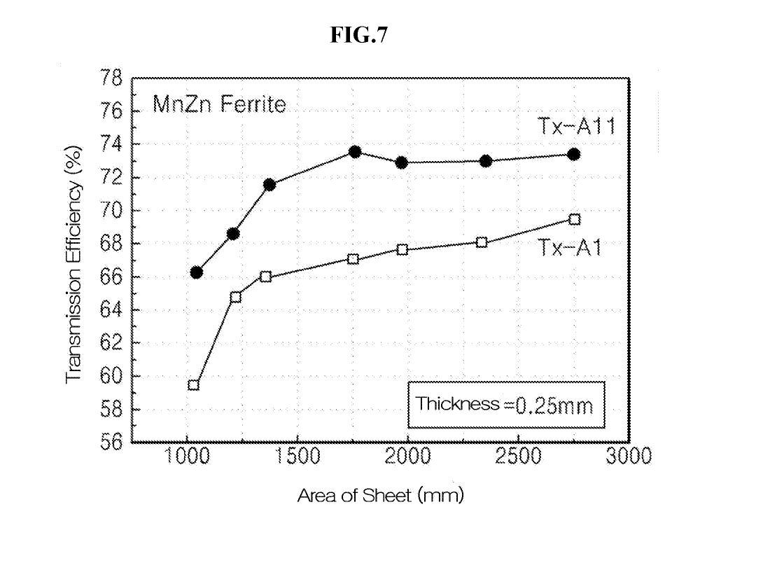

Graphs of experimental results in FIGS. 6 and 7 illustrate transmission efficiencies measured depending on an area of a sheet according to one embodiment of the present invention.

To measure transmission efficiency depending on an area of a magnetic member formed of an Fe—Si—B material and a magnetic member formed of an MnZn ferrite material, the areas of the sheets were changed from 1000 mm² to 3000 mm² while measuring the transmission efficiency.

Two thicknesses of the sheets of 0.1 mm and 0.25 mm were applied, an antenna applied for wireless power transmission is a lead frame LF5055ANT at a size of 50 mm by 55 mm, and a thickness of a coil is uniformly set to 0.1 mm. An area of the magnetic member applied is 50 mm by 55 mm (an area of 2750 mm²) as a maximum size, a space between the magnetic member and the antenna is 0.03 mm, and an input power is applied in the range of 2.5 W to 3.5 W (power transmission methods were Tx-A11 and Tx-A1).

As confirmed from the results in FIGS. 6 and 7, in spite of the difference of the transmission methods, the transmission efficiency in the range according to one embodiment of the present invention is securable up to the range of 62% to 69% when the area of the sheet is increased within the range satisfying the embodiment of the present invention, and thus it is confirmed that a desired degree (transmission efficiency for proper wireless charging) may be secured even in different transmission methods.

When the above-described results are taken together, by implementing the magnetic member according to one embodiment of the present invention to satisfy the ratio of the area of cross section to the thickness in the range of 1:(0.0002˜1), or, in addition, by implementing a volume of the magnetic member to satisfy the range of 10³ mm³ to 10¹² mm³, a high efficiency of wireless power transmission may be expected regardless of equipping a permanent magnet, an advantage of resolving a compatibility problem depending on differences in transmission methods is implemented, and a wide use of magnetic members which allows a variety of magnetic material to be selected regardless of a new standards is achievable. That is, by controlling an area and a thickness of the magnetic member, the highest level of transmission efficiency with various structures of magnetic members may be implemented and expansion to diverse application fields may be expected.

Hereinafter, an application of a magnetic member according to another embodiment of the present invention will be described. The above-described magnetic member may be applied to implement this embodiment as a matter of course. FIG. 8 is a view illustrating a wireless power conversion (WPC) system or a near field communication (NFC) system in which a magnetic member according to another embodiment of the present invention is applied.

Referring to FIG. 8, the WPC system or the NFC system is formed to include a transmitting device 200 and a receiving device 100. The transmitting device 200 is formed to include a transmitter coil 210, and the receiving device 100 is formed to include a receiver coil 110. The transmitter coil 210 is connected with a power source 201, and the receiver coil 110 is connected with a circuit 101.

The power source 201 may be an AC power source which provides an AC power at a predetermined frequency, and an AC current flows in the transmitter coil 210 by the power supplied from the power source 201.

When the AC current flows in the transmitter coil 210, an AC current is also induced in the receiver coil 110 physically separated from the transmitter coil 210 by electromagnetic induction.

The induced current in the receiver coil 110 is transferred to the circuit 101, and is then rectified to operate the receiving device 100.

Meanwhile, in the case of WPC system, the above-described transmitting device 200 may be formed as a transmission pad, and the receiving device 100 may be formed as a part of configurations in a handheld terminal, a household or personal electronic appliance, a transportation vehicle, or the like where the wireless power transmitting and receiving technologies are applied, or a handheld terminal, a household or personal electronic appliance, a transportation vehicle, or the like where the wireless power transmitting and receiving technologies are applied may only include the receiving device 100 or alternatively may include both of the wireless power transmitting device 200 and the wireless power receiving device 100.

In addition, in the case of NFC system, the above-described transmitting device 200 may be formed as a reader and the receiving device 100 may be formed as a tag.

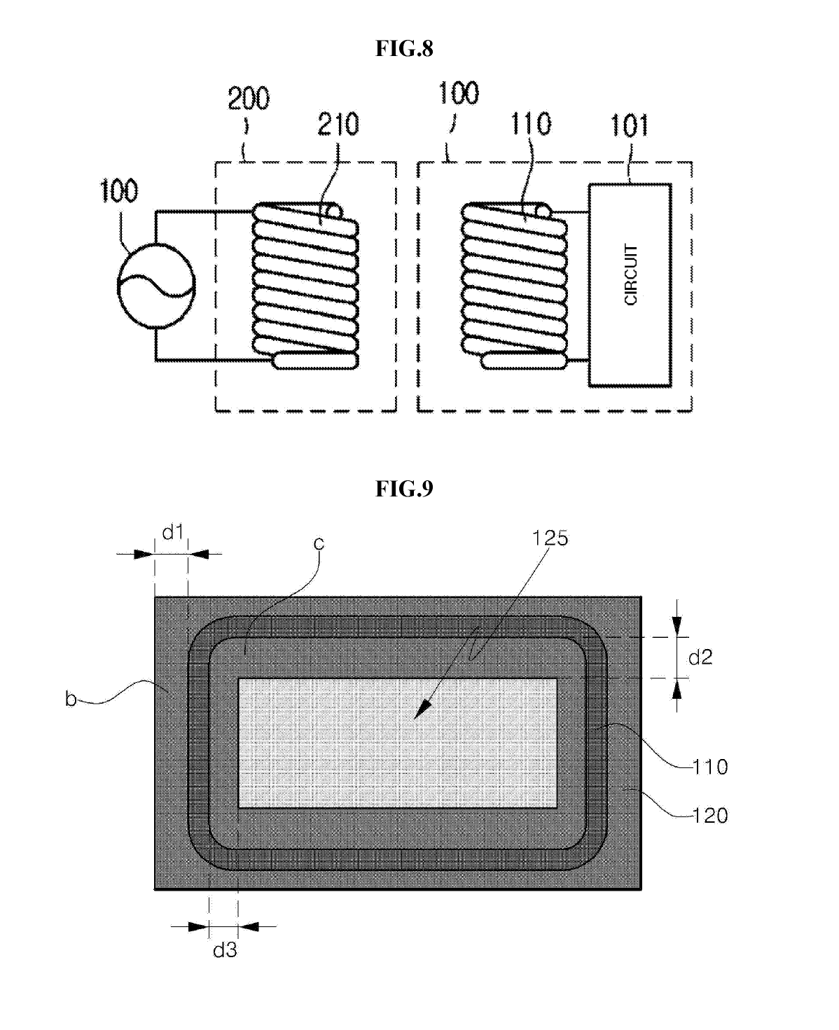

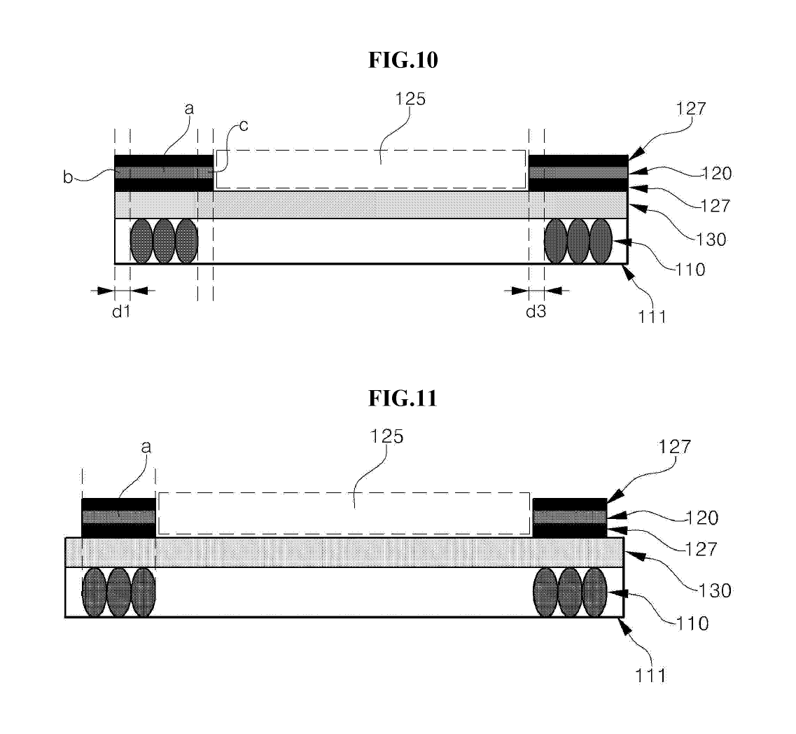

FIGS. 9 and 10 are conceptual diagrams illustrating a magnetic member which forms a transmitting device or a receiving device illustrated in FIG. 8 according to another embodiment of the present invention. More particularly, FIG. 9 is a top plan view of a magnetic member according to one embodiment of the present invention, and FIG. 10 is a cross sectional view of a magnetic member according to one embodiment of the present invention.

A structure of the magnetic member according to one embodiment of the present invention will be described with reference to FIGS. 9 and 10. The magnetic member according to the embodiment of the present invention may also be formed as a structure of a sheet or a substrate provided with a cross section which includes a first width x of a first direction, a second width y of a second direction perpendicular to the first direction, and a thickness z which extends from the cross section, particularly in the embodiment of the present invention a soft magnetic layer which includes an opening is formed in a thickness z direction.

That is, as illustrated in FIGS. 9 and 10, the magnetic member according to one embodiment of the present invention is formed to include a soft magnetic layer 120 and a coil pattern 110 which forms a receiving coil, and may be formed further including a protective layer 111 having the coil pattern 110, an adhesive layer 130, and a black film layer 127.

The coil pattern 110 is formed as a coil, and the coil may be formed as 3 to 4 turns.

The coil pattern 110 may be formed to be included in the protective layer 111.

Here, an inductance of the coil pattern 110 may be formed to be about 3.2 H, and the coil pattern 110 may be formed to have a width of 3 mm.

Meanwhile, the coil pattern 110 may be formed as various structures of polygons besides the shape illustrated in FIG. 10.

In addition, a soft magnetic layer 120 may be formed above the coil pattern 110, and an opening 125 is included inside the soft magnetic layer 120.

More specifically, as illustrated in FIGS. 9 and 10, the soft magnetic layer 120 may be disposed to include an area a which corresponds to the coil pattern 110, and areas b and c which extend from the area a which corresponds to the coil pattern 110. Here, the soft magnetic layer 120 may be formed to occupy in the range of 25% to 50% of an area on the magnetic member. That is, the soft magnetic layer 120 may be implemented to occupy in the range of 25% to 50% of the entire area of the magnetic member including the opening.

In addition, the soft magnetic layer 120 may be disposed to include the area a which corresponds to the coil pattern 110, and the areas b and c which extend 5 mm from the area a which corresponds to the coil pattern 110.

Alternatively, the soft magnetic layer 120 may be disposed to include the area c which extends 5 mm of widths d2 and d3 toward the opening 125 from the area a which corresponds to the coil pattern 110, and the area b which extends 1 mm of a width d1 toward an outer edge of the soft magnetic substrate from the area a which corresponds to the coil pattern 110. When the opening 125 is formed at the central portion of the soft magnetic layer 120 as described above, a recognition distance of a soft magnetic substrate from a reader may be formed to be a minimum recognition distance or more while reducing the area of the soft magnetic layer 120.

Meanwhile, the soft magnetic layer 120 may be formed by performing a punching process on an integrated soft magnetic layer, or formed as a combined structure by combining a plurality of separated magnetic structures. In other words, in the case that the soft magnetic layer 120 is formed as a combined structure by combining a plurality of separated magnetic structures, the soft magnetic layer 120 may be formed by assembling separated structures in a shape of a rectangle or a stick, or by assembling a L-shaped structure and a ┐-shaped structure.

The soft magnetic layer 120 formed as described above may further include an insulating material layer disposed between the coil pattern and the soft magnetic layer. The insulating material layer may be formed to include a material layer having an insulating property such as an adhesive layer, a protective film, or the like. As an embodiment, the coil pattern 110 may be provided with a protective layer 111 for the purpose of protecting the coil pattern 110, and may be bonded on the protective layer 111 by a medium of the adhesive layer 130. Further, at an upper surface or a lower surface of the soft magnetic layer 120, the shielding layer 127 may be formed, wherein the black film layer formed as the shielding layer will be taken as an example for explanation.

Meanwhile, the soft magnetic layer 120 may be formed to have a relative permeability in the range of 50 to 200, and may be formed of a ferrite which includes at least any one of Fe, Ni, Co, Mn, Al, Zn, Cu, Ba, Ti, Sn, Sr, P, B, N, C, W, Cr, Bi, Li, Y and Cd.

In addition, as illustrated in FIG. 10, the black film layer serving as the shielding layer 127 may be disposed on one surface and the other surface of the soft magnetic layer 120.

Further, according to another embodiment of the present invention, a second soft magnetic layer may be formed to be disposed in the opening 125.

The second soft magnetic layer may be formed of a material having a different permeability from that of the soft magnetic layer 120, and may be formed of a ferrite including at least any one of Fe, Ni, Co, Mn, Al, Zn, Cu, Ba, Ti, Sn, Sr, P, B, N C, W, Cr, Bi, Li, Y, and Cd, in the same manner as the soft magnetic layer 120.

FIG.11 is a cross sectional view of a soft magnetic substrate according to still another embodiment of the present invention.

In the same manner as the embodiment illustrated in FIGS. 9 and 10, a soft magnetic substrate according to the embodiment of FIG. 11 is formed to include a coil pattern 110 and a soft magnetic layer 120, and is formed to further include a protective layer 111 which includes the coil pattern 110, an adhesive layer 130, and a black film layer serving as a shielding layer 127.

The coil pattern 110 is formed to be included in the protective layer 111, and the soft magnetic layer 120 which includes an opening 125 therein is formed above the coil pattern 110.

In the embodiment of FIG. 11, the soft magnetic layer 120 may be formed to be disposed only at an area a which corresponds to the coil pattern 110.

When the opening 125 is formed at the central portion of the soft magnetic layer 120, a recognition distance of the soft magnetic substrate from a reader may be formed to be a minimum recognition distance or more while minimizing the area of the soft magnetic layer 120.

In the same manner, the soft magnetic layer 120 formed as above may be bonded above the protective layer 111 which includes the coil pattern 110 by a medium of the adhesive layer 130, and the shielding layer 127 as the black film layer may be disposed on one surface and the other surface of the soft magnetic layer 120.

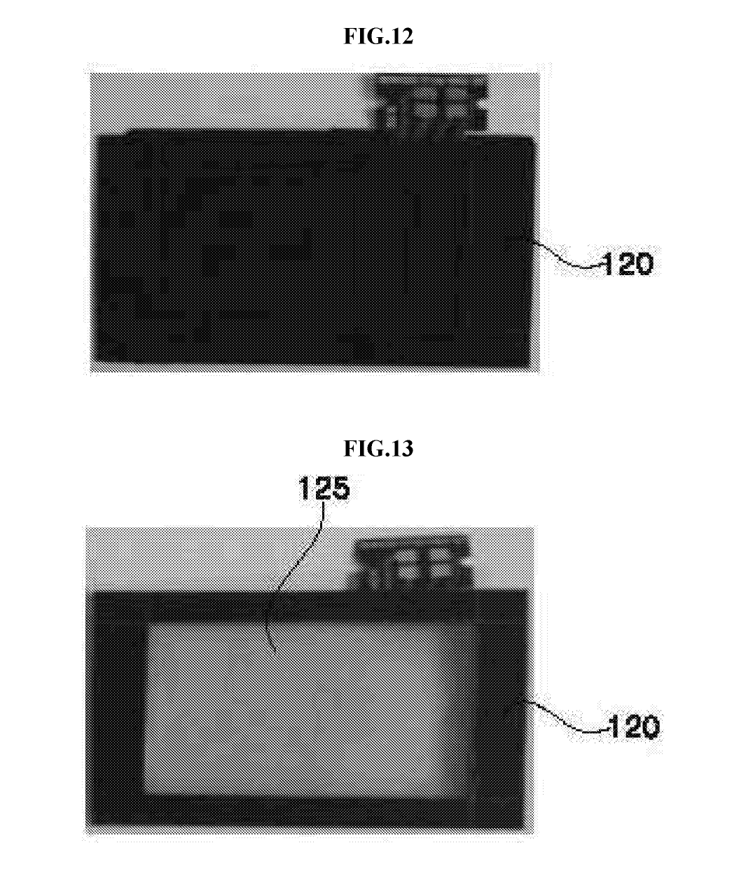

FIGS. 12 and 13 are views for describing a magnetic member according to one embodiment of the present invention.

FIG. 12 is a soft magnetic substrate according to a conventional art, in which a soft magnetic layer 120 is formed across the entire surface of a soft magnetic substrate, while a magnetic member having a soft magnetic according to one embodiment of the present invention as illustrated in FIG. 13 is formed to include a soft magnetic layer 120 having an opening 125.

More specifically, the soft magnetic substrate according to one embodiment of the present invention may form the soft magnetic layer 120 including the opening 125 by performing a punching process on an integrated soft magnetic layer, or the soft magnetic layer 120 may be formed by combining a plurality of separated magnetic structures.

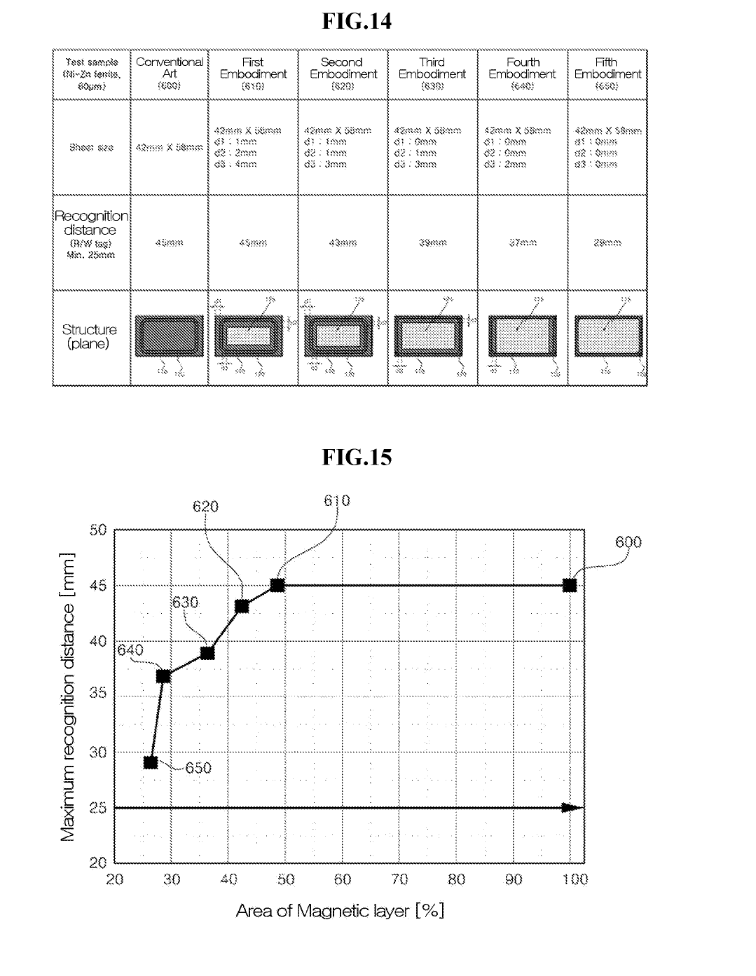

FIG. 14 is a table for describing recognition distances of magnetic members according to embodiments of the present invention, and FIG. 15 is a graph for describing the recognition distances of the magnetic members according to the embodiments of the present invention.

Referring to FIGS. 14 and 15, a case of forming a sheet size of the soft magnetic substrate according to the conventional art and sheet sizes of magnetic members according to first to a fifth embodiments of the present invention as 42 mm by 58 mm will be described.

Meanwhile, the horizontal axis of FIG. 15 represents an area percentage of a magnetic member that a soft magnetic layer occupies, and the vertical axis represents a recognition distance recognizable from a reader.

A soft magnetic substrate of a conventional art 600 has an exemplary embodiment covering a soft magnetic layer above a coil pattern required much expensive ferrite material when forming the soft magnetic layer because an opening is not formed at the soft magnetic layer, and the recognition distance from the reader is 45 mm.

A magnetic member according to a first embodiment 610 has an exemplary embodiment in which the soft magnetic layer 120 extends by a width d1 of 1 mm toward an edge end of the magnetic member, and extends by widths d2 of 2 mm and d3 of 4 mm from the coil pattern 110 toward the opening 125. The recognition distance from the reader is 45 mm, and the area percentage of the magnetic member that the soft magnetic layer 120 occupied is 49%.

In addition, a magnetic member according to a second embodiment 620 has an exemplary embodiment in which the soft magnetic layer 120 extends by a width d1 of 1 mm toward an edge end of the soft magnetic substrate, and extends by widths d2 of 1 mm and d3 of 3 mm from the coil pattern 110 toward the opening 125. The recognition distance from the reader is 43 mm, and the area percentage of the magnetic member that the soft magnetic layer 120 occupied is 42%.

In addition, a magnetic member according to a third embodiment 630 has an exemplary embodiment in which a width d1 of the soft magnetic layer 120 does not extend toward an edge end of the magnetic member, and the soft magnetic layer 120 extends by widths d2 of 1 mm and d3 of 3 mm from the coil pattern 110 toward the opening 125. The recognition distance from the reader is 39 mm, and the area percentage of the magnetic member that the soft magnetic layer 120 occupied is 36%.

In addition, a magnetic member according to a fourth embodiment 640 has an exemplary embodiment in which a width d1 of the soft magnetic layer 120 does not extend toward an edge end of the soft magnetic substrate, a width of the soft magnetic layer 120 does not extend from the coil pattern 110 toward a first side of the opening 125, and the soft magnetic layer 120 extends by a width d3 of 2 mm from the coil pattern 110 toward a second side of the opening 125. The recognition distance from the reader is 37 mm, and the area percentage of the magnetic member that the soft magnetic layer 120 occupied is 29%.

Lastly, a magnetic member according to a fifth embodiment 650 has an exemplary embodiment in which a width d1 of the soft magnetic layer 120 does not extend toward an edge end of the soft magnetic substrate, and widths d2 and d3 of the soft magnetic layer 120 does not extend from the coil pattern 110 toward a first and a second sides of the opening 125. The recognition distance from the reader is 29 mm, and the area percentage of the magnetic member that the soft magnetic layer 120 occupied is 26%.

In the third to fifth embodiments 630, 640 and 650 of the present invention, although the soft magnetic layer 120 does not extend from the coil pattern 110, the soft magnetic layer 120 is formable a bit off the coil pattern 110 because the coil pattern 110 is a structure having a curvature.

Accordingly, the magnetic member according to the embodiments of the present invention may form the recognition distance of the soft magnetic substrate from a reader to be a minimum recognition distance of 25 mm or more as well as reducing the area that the soft magnetic layer occupies at the magnetic member by forming the opening at the central portion of the soft magnetic layer disposed above the coil pattern.

While the invention has been shown and described with reference to certain exemplary embodiments thereof, it should be understood by those skilled in the art that various changes in form and details may be made therein without departing from the spirit and scope of the invention as defined by the appended claims. The inventive concept of the present invention is not limited to the embodiments described above, but should be defined by the claims and equivalent scope thereof.

### INDUSTRIAL APPLICABILITY

1. A magnetic member comprising:
a cross section provided with a first width x of a first direction and a second width y of a second direction perpendicular to the first direction; and
a thickness z which extends from the cross section,
wherein a ratio of an area of the cross section to the thickness z is in the range of 1:(0.0002˜1),
wherein the first width x is defined as the longest line segment of the cross section in a horizontal direction, and the second width y is defined as the longest line segment in a perpendicular direction to the first width.

2. The magnetic member of claim 1, wherein a volume of the magnetic member satisfies the range of 10³ mm³ to 10¹² mm³.

3. The magnetic member of claim 1, wherein the magnetic member is a structure of single layered sheet.

4. The magnetic member of claim 1, wherein the magnetic member is a stacked layer structure including at least two or more unit sheets.

5. The magnetic member of claim 4, further comprising an insulating material layer adjacent to the unit sheet.

6. The magnetic member of claim 4, wherein a thickness of the unit sheet is in the range of 18 um to 200 um.

7. The magnetic member of claim 4, wherein the unit sheet is formed of a composite material of a polymer and a metallic-alloy based magnetic powder formed of one element or a combination of two or more elements selected from Fe, Ni, Co, Mo, Si, Al, and B.

8. The magnetic member of claim 4, wherein the unit sheet includes a metallic-alloy based magnetic ribbon.

9. The magnetic member of claim 4, wherein the unit sheet includes a composite material of a polymer and a ferrite based powder formed of a combination of two or more elements selected from Fe, Ni, Mn, Zn, Co, Cu, Ca, and O, or a sintered ferrite.

10. A magnetic member comprising:
a soft magnetic layer which includes a cross section provided with a first width x of a first direction, a second width y of a second direction perpendicular to the first direction, a thickness z which extends from the cross section, and an opening in the thickness z direction; and
a coil pattern on the soft magnetic layer,
wherein the soft magnetic layer includes an area which corresponds to the coil pattern, and an area which extends from the area which corresponds to the coil pattern.

11. The magnetic member of claim 1, wherein the soft magnetic layer occupies in the range of 25% to 50% of an entire area of the magnetic member including the opening.

12. The magnetic member of claim 11, wherein the soft magnetic layer is a combined structure of a plurality of separated magnetic structures.

13. The magnetic member of claim 10, further comprising an insulating material layer disposed between the coil pattern and the soft magnetic layer.

14. The magnetic member of claim 13, wherein the insulating material layer is a stacked structure including at least two or more layers.

15. The magnetic member of claim 14, wherein the insulating material layer includes shielding layers which cover one side and the other side of the soft magnetic layer.

16. The magnetic member of claim 10, wherein the soft magnetic layer is formed of a ferrite which includes at least any one of Fe, Ni, Co, Mn, Al, Zn, Cu, Ba, Ti, Sn, Sr, P, B, N, C, W, Cr, Bi, Li, Y, and Cd.

17. The magnetic member of claim 10, wherein the soft magnetic layer has a relative permeability in the range of 50 to 200.

18. The magnetic member of claim 10, further comprising a second soft magnetic layer disposed at the opening.

19. The magnetic member of claim 10, wherein a permeability of the soft magnetic layer is different from that of the second soft magnetic layer.

20. A wireless power transmission device comprising the magnetic member of claim 1.

21. A wireless power transmission device comprising the magnetic member of claim 10.
